(19) United States
(12) Patent Application Publication
(10) Pub. No.: US 2007/0038562 A1
(43) Pub. Date: Feb. 15, 2007

(54) Contractual structure for delinking a bank rating from rating of a special purpose vehicle

(76) Inventors: Shervyn J. von Hoerl, New York, NY (US); Nancy Henderson, New York, NY (US); Tom Glynn, Wilton, CT (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/200,664

(22) Filed: Aug. 9, 2005

(51) Int. Cl. G06Q 40/00

(52) U.S. Cl. 705/40

(57) ABSTRACT

A contractual structure among first, second, and third companies is disclosed, wherein the first company is typically a special purpose vehicle. The first company has a payment obligation to one or more entities in accordance with one or more schedules, the payment obligation comprising a principal component and an interest component. The second company enters into a first set of one or more derivative contracts with the first company and a second set of one or more derivative contracts with the third company. The first contract set apportions risks and rewards between the first and second companies of a possible default or value change of one or more assets referenced in the first contract set. The second contract set obligates the third company to make collateral funds available to the first company to fully enable or assist the first company in fulfilling the payment obligation to the one or more entities. At least a portion of the collateral funds is contingent upon a default or depreciation of the one or more referenced assets. The first contract set also includes an assignment of the second company's rights under the second contract set to the first company. This arrangement advantageously delinks the rating of the first company from that of the second company, due to the collateral funds that are provided by the third company and in the control of the first company.

### BACKGROUND OF THE INVENTION

1. Field of the Invention

The present invention relates generally to derivative transactions and specifically to contractual arrangements involving special purpose vehicles.

2. Description of the Related Art

A swap is an exchange of streams of payments over time according to specified terms. The most common type of swap is an interest rate swap, in which one party agrees to pay a fixed interest rate in return for receiving an adjustable rate from another party.

A derivative is a financial instrument whose characteristics and value depend upon the characteristics and value of an underlier, typically a commodity, bond, equity or currency. Examples of derivatives include futures and options. Advanced investors sometimes purchase or sell derivatives to manage the risk associated with the underlying security, to protect against fluctuations in value, or to profit from periods of inactivity or decline.

The International Swaps and Derivatives Association (ISDA) is a global trade association representing participants in the privately negotiated derivatives industry, a business covering swaps and options across all asset classes (interest rate, currency, commodity and energy, credit and equity). ISDA was chartered in 1985, and today numbers over 625 member institutions from 47 countries on six continents. These members include most of the world's major institutions who deal in, as well as leading end-users of, privately negotiated derivatives. The membership includes associated service providers and consultants.

One of the ISDA's notable accomplishments is the development of the ISDA Master Agreement and supporting documents for swaps and derivatives transactions. In any given transaction, the parties will each assume obligations. Negotiating contracts covering such transactions can take significant effort and time. This problem is overcome by using a Master ISDA Agreement, which is a standard agreement governing swaps and derivatives trading, using market standard terms and documentation. For example, “total return swap agreements” can be documented and governed by a Master ISDA Agreement, an “ISDA Schedule,” and one or more “ISDA Confirmations,” as known in the swaps and derivatives field. The Master ISDA Agreement is basically a set of definitions and fulfills to a large extent the need for standardization. In general, all Master ISDA Agreements are substantially identical. The ISDA Schedule tailors the terms of the Master ISDA Agreement to suit the relationship between the parties and the institutional stance on particular issues. After signing the Master ISDA Agreement and an ISDA Schedule, the parties still have not actually entered into a transaction - neither party has assumed any financial obligation to the other yet. In order to create this financial obligation, the parties enter into one or more ISDA Confirmations, each of which sets forth the economic terms of a derivatives transaction.

Rating agencies such as Fitch, Moody's, and S&P assign ratings to debtors and debt instruments based on the condition of the debtor. In assigning such ratings, the rating agencies assess (i) the probability of default by the debtor, and/or (ii) the ability of the debtor to make timely payments to the holders of the debt instruments (e.g., commercial paper, medium-term notes, etc.). If there is a material risk that the debtor will default or will not have enough liquidity to pay its investors, then the debt instruments cannot be rated in the highest rating category.

A special purpose vehicle (SPV) is a company whose operations are limited to the acquisition and financing of specific assets. A special purpose vehicle is sometimes referred to as a special purpose entity or special purpose corporation. For example, one type of SPV is a subsidiary company with an asset/liability structure and legal status that makes its obligations secure even if the parent company goes bankrupt. Since an SPV typically does not carry the risks of a traditional operating company and is therefore at a lower risk of insolvency, it can normally issue notes with a higher credit rating to investors.

By serving as a counterparty for swaps and other credit-sensitive derivative instruments (such as, for example, total rate of return swaps or credit default swaps), an SPV can be used to shift and isolate financial risks and rewards among companies. For example, FIG. 1 shows a known contractual arrangement between a first company 1, a second company 2, and a third company 3. The first company 1 is an SPV that has been established for the purpose of entering into total return swap agreements (in this example, with the second company 2), issuing short term notes to investors 4 in the U.S. market, and purchasing eligible assets with the proceeds of such issuance. The short term notes obligate the first company 1 to pay its investors 4 the face value of the notes on the notes' maturity date. The first company's payment obligation to the investors 4 comprises a principal component (repayment of the amount for which the notes were sold) and an interest component. The second company 2 can be a bank or other type of company. The second company 2 has entered into total return swap agreements (each a “hedge contract”) with the first company 1, perhaps under a Master ISDA Agreement between the two parties. Each hedge contract obligates the second company 2 to make payments to the first company 1 (typically on or before the notes' maturity date) that are sufficient to be used by the first company 1 to fulfill the interest component of its payment obligation to the investors 4. Each hedge contract also references a separate asset or pool of assets (e.g., bonds, equity, loans) and provides that the risks and rewards of asset appreciation and depreciation are passed onto the second company 2. In other words, if the assets increase in value, then the first company 1 is obligated to pay the second company 2 the amount of appreciation. Likewise, if the assets decrease in value, then the second company 2 is obligated to pay the first company 1 the amount of depreciation. Typically, the first company 1 will use the proceeds from the issuance of the short term notes to purchase the referenced assets (or assets of substantially equal value and/or character), to hedge its obligation to the second company 2. Typically, the total value of the assets is substantially equal to the total principal component of the first company's payment obligation to the investors 4.

The second company 2 has also entered into “mirror total return swap agreements” (also referred to as a “mirror swaps” and/or “eligible swap agreements”) with an eligible third company 3 (also referred to as a “swap counterparty” or simply “counterparty”) in connection with each referenced asset or pool of assets. To be eligible as a swap counterparty, the third company typically has to have a rating at or above an identified threshold. The mirror swaps can also be governed by a Master ISDA Agreement between the second company 2 and third company 3. In fact, the mirror swaps can (but need not) be substantially identical to the total return swap agreements between the first company 1 and the second company 2. Each mirror swap obligates the third company 3 to make payments to the second company 2 that are sufficient to be used by the second company 2 to make its required payments to the first company 1 in connection with the interest component of the payment obligation to the investors 4. Each mirror swap references the same asset or pool of assets of a corresponding hedge contract (between the first and second companies) and provides that the risks of asset depreciation and rewards of asset appreciation are passed from the second company 2 onto the third company 3. In other words, if the assets increase in value, then the second company 2 is obligated to pay the third company 3 the amount of appreciation. Likewise, if the assets decrease in value, then the third company 3 is obligated to pay the second company 2 the amount of depreciation. If, just prior to the notes' maturity date, the assets have depreciated, then the first company 1 can pay the principal component of its payment obligation to the investors 4 with proceeds obtained by selling the assets combined with the depreciation payment from the second company 2.

Thus, this arrangement allows the third company 3 to receive all of the risks and rewards stemming from the appreciation or depreciation of each referenced asset or pool of assets, without actually owning such assets. These risks and rewards are passed from the first company 1 to the third company 3, through the intermediary second company 2. Note that the second company 2 is not essential to the arrangement, as the third company 3 could simply enter into total return swap agreements (perhaps with a Master ISDA Agreement, ISDA Schedule, and ISDA Confirmations) with the first company 1. However, that would often require the third company 3 to form the first company 1 for this purpose. The swaps and derivatives industry has spawned intermediary actors (in this case the second company 2) that form SPV's (such as the first company 1) for the benefit of clients (in this case the third company 3) that wish to receive the risks and rewards of asset appreciation and depreciation without “direct exposure” (i.e., ownership) to the assets. These intermediary actors typically charge a fee for facilitating the transaction.

From the point of view of the third company 3, a significant advantage of this arrangement is that it requires a potentially smaller expenditure of liquid funds than would be necessary to purchase the referenced assets outright. The required payments under the mirror swaps would be expected to be less than the actual value of the referenced assets. The risks and rewards of asset ownership can be obtained without actual ownership. Banks may derive an additional benefit from this arrangement. Under federal regulations, when a bank owns assets or enters into a derivative contract, the bank has to maintain a certain amount of capital reserves to hedge against the possibility that the assets or a derivative counterparty may default. The amount of capital reserves required for an exposure to a counterparty under a derivative transaction is potentially less than the capital reserves required for owning the assets outright. In the arrangement illustrated in FIG. 1, the third company 3 does not own the referenced assets. Its exposure is to the second company 2, not the referenced assets. If the third company 3 is a bank, it may not need to maintain as much capital reserves in order to comply with the federally mandated capital requirements.

From the point of view of the first company 1, it has a right to receive payments from the second company 2, which can be used to meet the first company's obligation to its investors 4. The obligation of the third company 3 to make payments to the second company 2 reduces the risk that the second company 2 will be unable to meet its obligation to the first company 1.

A credit default swap is an agreement in which a first company agrees to pay a second company a premium (either at one time or in periodic payments) in exchange for the second company's agreement to pay the first company defined losses incurred by the first company due to a default of one or more assets referenced in the agreement. For example, the first company may own (or be exposed to via a derivative agreement) assets such as bonds. In an exemplary credit default swap, the first company pays a premium to the second company in exchange for the second company's agreement to cover the first company's losses in the event that the bond-issuer defaults on the bonds.

### SUMMARY OF THE INVENTION

Embodiments of the present invention address problems associated with the credit and liquidity support provided to a company, such as a special purpose vehicle. In various aspects, the present invention provides contractual structures and methods for improving such credit and liquidity support and ensuring sufficient capital irrespective of the bankruptcy of an entity from which the company receives money to meet its obligations.

In one aspect, the present invention provides a contractual structure comprising first, second, and third companies, a first set of one or more derivative contracts (“first contract set”) between the first and second companies, and a second set of one or more derivative contracts (“second contract set”) between the second and third companies. The first company has a payment obligation to one or more entities in accordance with one or more schedules. The first contract set apportions risks and rewards between the first and second companies of a possible default or value change of one or more assets referenced in the first contract set. The second contract set obligates the third company to make collateral funds available to the first company to fully enable or assist the first company in fulfilling the payment obligation to the one or more entities. At least a portion of the collateral funds is contingent upon a default or depreciation of the one or more referenced assets. In a preferred embodiment, the first contract set includes an assignment of the second company's rights under the second contract set to the first company.

In another aspect, the present invention provides a method comprising the following steps, not necessarily in this order. A first set of one or more derivative contracts is entered into with a first company that has a payment obligation to one or more entities in accordance with one or more schedules. The method includes agreeing under the first contract set to an apportionment with the first company of risks and rewards associated with a possible default or value change of one or more assets referenced in the first contract set. A second set of one or more derivative contracts is entered into with a counterparty, the second contract set obligating the counterparty to make collateral funds available to the first company to fully enable or assist the first company in fulfilling the payment obligation to the one or more entities. At least a portion of the collateral funds is contingent upon a default or depreciation of the one or more referenced assets. In a preferred embodiment, the method further comprises assigning all rights obtained under the second contract set to the first company.

In still another aspect, the present invention provides a method comprising the following steps, not necessarily in this order. The method involves assuming a payment obligation to one or more entities in accordance with one or more schedules. A first set of one or more derivative contracts is entered into with an intermediary company, wherein the intermediary company enters into a second set of one or more derivative contracts with a counterparty. The method includes agreeing under the first contract set to an apportionment with the intermediary company of risks and rewards associated with a possible default or value change of one or more assets referenced in the first contract set. A right is obtained under the second contract set to receive from the counterparty collateral funds that can be used to at least partially fulfill the payment obligation to the one or more entities. At least a portion of the collateral funds is contingent upon a default or depreciation of the one or more assets. In a preferred embodiment, the method further comprises obtaining under the first contract set an assignment by the intermediary company of the intermediary company's rights under the second contract set.

In yet another aspect, the present invention provides a method in which an intermediary company has entered into a first set of one or more derivative contracts with a first company that has a payment obligation to one or more entities in accordance with one or more schedules, the first contract set apportioning between the first company and the intermediary company risks and rewards associated with a possible default or value change of one or more assets referenced in the first contract set. The method comprises entering into a second set of one or more derivative contracts with the intermediary company, and agreeing under the second contract set to make collateral funds available to the first company to fully enable or assist the first company in fulfilling the payment obligation to the one or more entities. At least a portion of the collateral funds is contingent upon a default or depreciation of the one or more referenced assets. In a preferred embodiment, the first contract set includes an assignment of the intermediary company's rights under the second contract set to the first company.

For purposes of summarizing the invention and the advantages achieved over the prior art, certain objects and advantages of the invention have been described herein above. Of course, it is to be understood that not necessarily all such objects or advantages may be achieved in accordance with any particular embodiment of the invention. Thus, for example, those skilled in the art will recognize that the invention may be embodied or carried out in a manner that achieves or optimizes one advantage or group of advantages as taught herein without necessarily achieving other objects or advantages as may be taught or suggested herein.

All of these embodiments are intended to be within the scope of the invention herein disclosed. These and other embodiments of the present invention will become readily apparent to those skilled in the art from the following detailed description of the preferred embodiments having reference to the attached figures, the invention not being limited to any particular preferred embodiment(s) disclosed.

### BRIEF DESCRIPTION OF THE DRAWINGS

FIG. 1 illustrates a conventional contractual structure involving a special purpose vehicle.

FIG. 2 illustrates a contractual structure in accordance with one embodiment of the present invention.

### DETAILED DESCRIPTION OF THE PREFERRED EMBODIMENTS

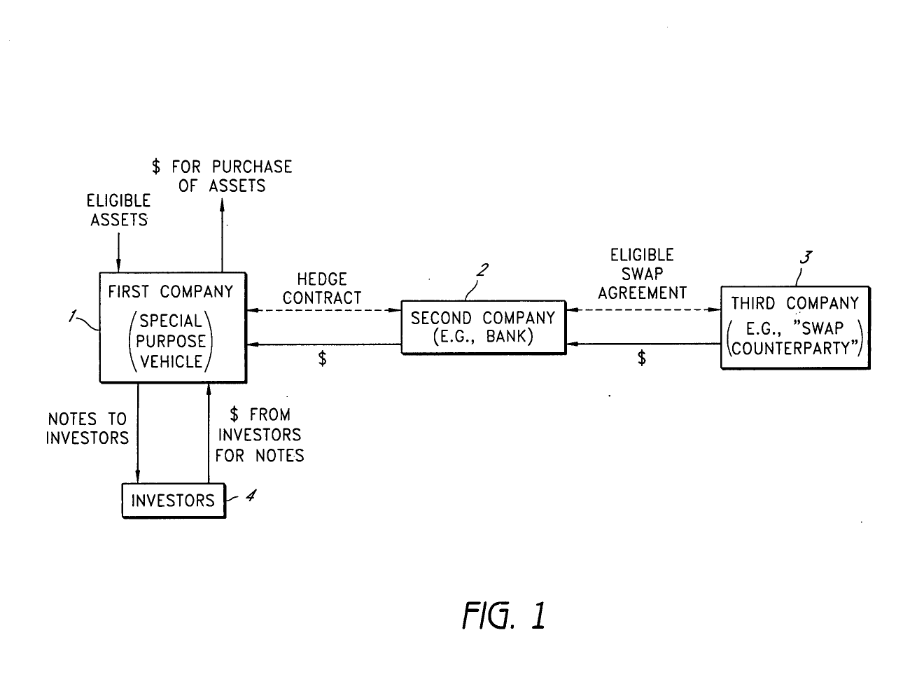

Several aspects of the conventional contractual structure illustrated in FIG. 1 limit the ratings of the notes issued by the first company 1. The notes' ratings depend upon the ratings of the second company 2. If the second company 2 is at risk of liquidity or credit problems, then so is the first company 1. If the second company 2 is an operating company, with operating costs and obligations to other entities, then credit agencies may assign ratings to it that reflect these potential burdens on liquidity and credit. In other words, the credit and liquidity support that the second company 2 can offer the first company 1 is limited. This can reduce the ratings of the notes issued by the first company 1, which would require the first company 1 to pay its investors 4 a higher interest rate and could even impair its ability to conduct business altogether. Moreover, if the second company 2 becomes subject to an insolvency proceeding, then the bankruptcy court or administrator can delay, interfere with, or stop the second company's payments to the first company 1, which can jeopardize the first company's ability to make timely payments to its investors 4.

On the contrary, if the second company 2 is itself a bankruptcy-remote entity and not an operating company, then credit agencies are more likely to give the second company a higher rating. This is because the second company 2 would have few, if any, unrelated obligations to other entities and could therefore provide better credit and liquidity support to the first company 1 (assuming that the second company 2 has appropriate sources of liquidity and is of sufficient credit quality). However, this would limit the ability of the second company 2 to enter into unrelated transactions and conduct unrelated business.

Another problem is the risk of “set-off.” Set-off is a common law concept that permits a party who owes money to a creditor to set-off (or reduce) that obligation by an amount owed by the creditor to the party under a separate obligation. Set-off is possible only when both obligations are due and payable. A contingent or unmatured obligation of a creditor cannot be set-off against a matured obligation that is due and payable. In the contractual structure of FIG. 1, the third company 3 could be the holder of an obligation of the second company 2 unrelated to the mirror swaps. If this unrelated obligation is matured and due and payable, the third company 3 may be able to set-off this obligation against money owed by the third company 3 to the second company 2 under the mirror swap. If the third company 3 exercises its set-off rights, the second company 2 may not have enough money to make its payments to the first company 1, again producing a potential liquidity problem for the first company.

Thus, the condition of the second company 2, in particular whether it has low credit ratings or unrelated obligations to the third company 3 that can lead to set-off, can lower the ratings of the notes issued by the first company 1. If the notes have lower ratings, the first company 1 has to pay its investors 4 a higher interest rate, which of course is undesirable from the standpoint of the first company 1. Furthermore, the lower ratings could cause the investors to lose interest in the first company's notes altogether.

Preferred embodiments of the present invention provide a contractual arrangement or structure that overcomes these problems. The invention involves the use of “derivative contracts,” which are to be construed in accordance with the definition of “swap agreement” set forth in the Bankruptcy Abuse Prevention and Consumer Protection Act of 2005, which was signed into law on Apr. 20, 2005. The Act defines “swap agreement” as follows:

“‘swap agreement’ means—(I) any agreement, including the terms and conditions incorporated by reference in any such agreement, which is an interest rate swap, option, future, or forward agreement, including a rate floor, rate cap, rate collar, cross-currency rate swap, and basis swap; a spot, same day-tomorrow, tomorrow-next, forward, or other foreign exchange or precious metals agreement; a currency swap, option, future, or forward agreement; an equity index or equity swap, option, future, or forward agreement; a debt index or debt swap, option, future, or forward agreement; a total return, credit spread or credit swap, option, future, or forward agreement; a commodity index or commodity swap, option, future, or forward agreement; or a weather swap, weather derivative, or weather option; (II) any agreement or transaction that is similar to any other agreement or transaction referred to in this clause and that is of a type that has been, is presently, or in the future becomes, the subject of recurrent dealings in the swap markets (including terms and conditions incorporated by reference in such agreement) and that is a forward, swap, future, or option on one or more rates, currencies, commodities, equity securities or other equity instruments, debt securities or other debt instruments, quantitative measures associated with an occurrence, extent of an occurrence, or contingency associated with a financial, commercial, or economic consequence, or economic or financial indices or measures of economic or financial risk or value; (III) any combination of agreements or transactions referred to in this clause; (IV) any option to enter into any agreement or transaction referred to in this clause; (V) a master agreement that provides for an agreement or transaction referred to in subclause (I), (II), (III), or (IV), together with all supplements to any such master agreement, without regard to whether the master agreement contains an agreement or transaction that is not a swap agreement under this clause, except that the master agreement shall be considered to be a swap agreement under this clause only with respect to each agreement or transaction under the master agreement that is referred to in subclause (I), (II), (III), or (IV); and (VI) any security agreement or arrangement or other credit enhancement related to any agreements or transactions referred to in subclause (I), (II), (III), (IV), or (V), including any guarantee or reimbursement obligation in connection with any agreement or transaction referred to in any such subclause. Such term is applicable for purposes of this subsection only and shall not be construed or applied so as to challenge or affect the characterization, definition, or treatment of any swap agreement under any other statute, regulation, or rule, including the Securities Act of 1933, the Securities Exchange Act of 1934, the Public Utility Holding Company Act of 1935, the Trust Indenture Act of 1939, the Investment Company Act of 1940, the Investment Advisers Act of 1940, the Securities Investor Protection Act of 1970, the Commodity Exchange Act, the Gramm-Leach-Bliley Act, and the Legal Certainty for Bank Products Act of 2000.”

As used herein, a “bankruptcy-remote entity” is an entity whose ownership is such that it will not be caught up in the bankruptcy of the owner. It typically must have a limited business purpose and own a limited type of assets, usually financial assets that are directly related to the company's limited business purpose. For example, a bankruptcy-remote entity generally cannot own real property because it would expose the entity to risks such as tradesman's liens or personal injury liability. Typically, a bankruptcy-remote entity is required to have one or more independent directors on its board, and its by-laws or articles of incorporation ordinarily state that the company needs a unanimous vote of the board of directors to commence voluntary bankruptcy proceedings. In order for a company to be bankruptcy-remote, each party that enters into a material agreement with the company is normally required to covenant that it will not start involuntary bankruptcy proceedings against the company until one year and one day have elapsed since the rated debt issued by or entered into by the company (e.g., notes issued to investors, or other debt instruments) has been repaid by the company. For example, if a financial service provider becomes an obligee of the company (e.g., by charging fees for services performed), the service provider must promise not to initiate involuntary bankruptcy proceedings against the company until more than a year after the company's rated debt is repaid. Finally, in order to be bankruptcy-remote, a company typically must take the necessary steps to maintain its distinct corporate existence (i.e., have its own books and records, bank accounts, etc.). An SPV can be, but is not necessarily, bankruptcy-remote.

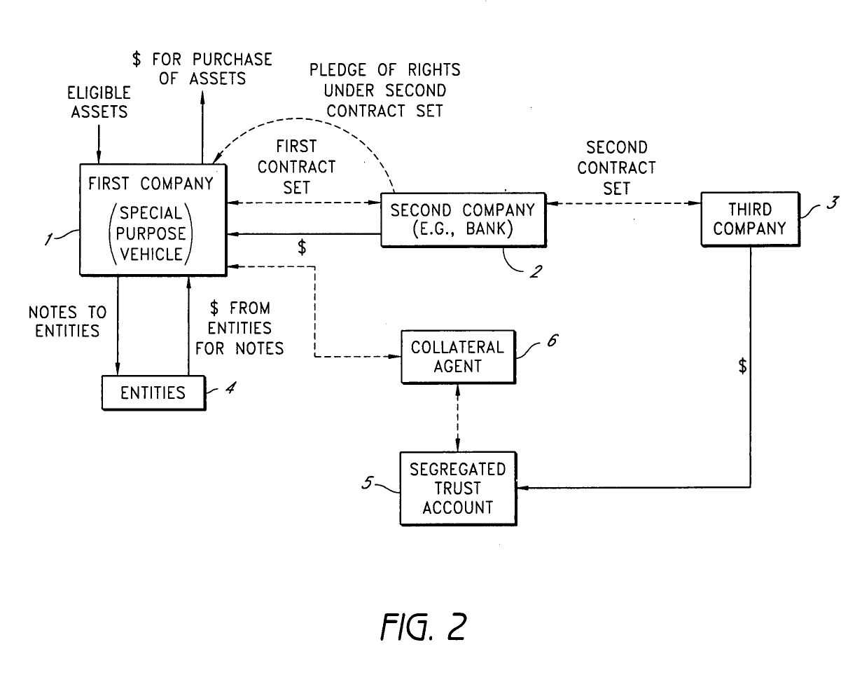

FIG. 2 illustrates a contractual structure according to one embodiment of the invention. This structure is similar to that of FIG. 1 in certain respects and involves the same three companies 1, 2, and 3. The first company 1 is obligated to make payments to one or more entities 4 in accordance with one or more schedules. For example, the first company 1 may have issued debt instruments (e.g., commercial paper, medium-term notes, etc.) to investors, or entered into loan agreements with lenders. The debt instruments specify repayment in accordance with the schedules associated with the debt instruments. The first company's payment obligation to the entities 4 comprises a principal component and an interest component. For example, the first company 1 might issue short term notes with a face value of $100, at a discounted value of $98. This means that the investors buy the notes for $98, and the first company 1 has to pay back $100 on the notes' maturity date. In this case, the principal component is $98 and the interest component is $2. It will be understood that the entities 4 can comprise any of a wide variety of different types of actors and combinations thereof, including without limitation individual investors, institutional investors, investment groups, etc.

With continued reference to FIG. 2, the second company 2 enters into a first set of one or more derivative contracts with the first company 1. This “first contract set” references one or more assets and apportions risks and rewards between the first and second companies of a possible default or value change of the assets. For example, the first contract set may comprise total return swap agreements that assign the risks and rewards of asset appreciation/depreciation to the second company 2. In another example, the first contract set may comprise credit default swap agreements under which the second company 2 agrees to pay the first company 1 defined losses in the event that the assets default. Such losses may result because the first company 1 owns or is exposed to the assets via a derivative contract. For example, the assets might be bonds for which the bond-issuer defaults on payment. The first contract set preferably defines with sufficient specificity the first company's losses in the event of asset default or value change. The first contract set can also obligate the first company 1 to pay the second company 2 any return associated with ownership of the referenced assets. For example, the assets can be bonds that yield interest payments, or equities that yield dividends. The total value of the assets, at the time that the first and/or second contract sets are executed, is preferably equal to the principal component of the first company's payment obligation to the entities 4.

In the illustrated embodiment, this first contract set comprises total rate of return swap agreements. In one arrangement, the first contract set obligates the second company 2 to make one or more payments to the first company 1 that are sufficient to be used by the first company to fulfill the interest component of the first company's payment obligation to the entities 4. In one embodiment, the first contract set obligates the second company 2 to pay a fixed or floating rate of interest on a notional amount, wherein the notional amount is ordinarily substantially equal to the principal component of the first company's payment obligation to the entities 4. The amount of the fixed or floating rate of interest (e.g., 3 month LIBOR plus 0.15%) is preferably selected so that the second company's payments are equal to or exceed said interest component. This serves to ensure that the first company 1 has enough money to pay the interest owed to the entities 4.

If the first contract set comprises total rate of return swaps, it preferably assigns the risks and rewards of asset value fluctuation onto the second company 2. In other words, the first contract set preferably obligates the first company 1 to pay the second company 2 an amount of appreciation, if any, of the referenced assets. Also, the first contract set preferably obligates the second company 2 to pay the first company 1 an amount of depreciation, if any, of the referenced assets. Skilled artisans will appreciate that both of these obligations are contingent upon whether the assets appreciate or depreciate. The second company's obligation to pay any depreciation of the assets assists the first company 1 in fulfilling the principal component of its payment obligation to the entities 4. In a typical arrangement, the first company 1 can fulfill the principal component from proceeds obtained by selling the assets (or equivalent assets) at the depreciated amount, supplemented by the depreciation payment received from the second company 2. On the other hand, if the assets appreciate, then the first company 1 can easily satisfy the principal component obligation from proceeds obtained by selling the assets at their increased value. The first company 1 can then pay the remaining appreciation to the second company 2, in accordance with its obligations under the first contract set.

In an alternative embodiment, the first contract set comprises credit default swap agreements that obligate the second company 2 to pay the first company 1 defined losses incurred by the first company in the event of a default of the one or more referenced assets. It will be understood that this is a contingent obligation, because it depends on whether the assets default. For example, a “default” of the assets can be defined with reference to standard ISDA documentation described above. Typically, the first company 1 will be obligated to make one or more premium payments to the second company 2 in exchange for this benefit. The credit default swaps can additionally be (but typically are not) structured to pass the risks and rewards of asset appreciation/depreciation onto the second company 2. In other words, the first contract set can obligate (1) the first company 1 to pay the second company 2 an amount of appreciation, if any, of the referenced assets, and (2) the second company 2 to pay the first company 1 an amount of depreciation, if any, of the referenced assets.

In the embodiment illustrated in FIG. 2, the first company's obligations to the entities 4 are based on notes (e.g., short term notes) issued by the first company 1. However, those of skill in the art will appreciate that the obligations can be based on any of a number of different types of transactions, without departing from the spirit and scope of the present invention. For example, the obligations of the first company 1 to the entities 4 can be based on transactions such as loans or derivative contracts. In a loan transaction, the first company 1 has borrowed money from investors and might be obligated to pay them back in a string of payments. One type of derivative transaction is an offsetting swap agreement in which the first company 1 acts as a counterparty with respect to another company that actually owns the assets (or assets of similar value and/or character).

In some embodiments, the first contract set may require the first company 1 to purchase the referenced assets or assets of substantially equal value and/or character. In other embodiments, the first contract set does not levy this requirement onto the first company 1. Skilled artisans will understand that, in any case, the first company 1 will likely be motivated to hedge its obligation to the second company 2 either by purchasing assets or entering into an offsetting derivative contract set.

The first contract set can provide that the second company's obligation to make its payments to the first company 1 can be satisfied if the first company forecloses on collateral paid by a third party that meets specific eligibility requirements. The first contract set can require that the collateral comprises a first portion that is sufficient to be used by the first company 1 to fulfill the interest component of the payment obligation to the one or more entities 4, and possibly a second portion that assists the first company 1 in fulfilling the principal component of the payment obligation. For example, the eligibility requirements can mandate that the third party has credit ratings at or above identified thresholds and enters into a set of one or more derivative contracts that obligates the third party to make collateral funds available to the first company 1 in an amount that is substantially equal to or greater than the interest component and the amount of depreciation of the assets, if any.

In the illustrated example, the third company 3 enters into a second set of one or more derivative contracts (e.g., total rate of return swaps, credit default swaps, etc.) with the second company 2. The “second contract set” preferably substantially mirrors the first contract set, with the exception that it is between the second and third companies. However, as explained below, the payment obligations of the third company 3 are preferably assigned by the second company 2 to the first company 1 under the first contract set. On the basis of this assignment, the third company 3 is required to make collateral funds available to the first company 1. Accordingly, the second contract set preferably obligates the third company 3 to make collateral funds available to the first company 1 to fully enable or assist the first company in fulfilling the payment obligation to the entities 4. Preferably, the second contract set references the same one or more assets identified in the first contract set, and at least a portion of the collateral funds is contingent upon a default or depreciation of the one or more referenced assets. In the illustrated embodiment, the second contract set obligates the third company 3 to pay the collateral funds into an account 5 owned by the first company 1. Preferably, the account 5 is a segregated trust account under the sole dominion and control of a collateral agent 6.

For example, in the illustrated embodiment the second contract set comprises total rate of return swaps, which preferably mirror the first contract set (i.e., the first contract set also comprises total rate of return swaps). In this case, the collateral funds preferably comprise (1) one or more payments sufficient to be used by the first company to fulfill the interest component of the payment obligation to the entities 4, and (2) an amount of depreciation, if any, of the one or more assets. This depreciation payment assists the first company 1 in fulfilling the principal component of its payment obligation to the entities 4. Also, the total rate of return swaps preferably fully transfer the risks and rewards of asset value fluctuation from the second company 2 to the third company 3. Accordingly, the second contract set preferably further obligates the second company 2 to pay the third company 3 an amount of appreciation, if any, of the referenced assets. In addition, the second contract set can also obligate the second company 2 to pay the third company 3 any return associated with ownership of the referenced assets.

In an alternative embodiment, the second contract set comprises one or more credit default swap agreements, which preferably mirror the first contract set (i.e., the first contract set also comprises credit default swaps). The credit default swaps obligate the third company 3 to pay the aforementioned defined losses incurred in the event of a default of the one or more referenced assets. It will be understood that this is a contingent obligation, because it depends on whether the assets default. Typically, the second company 2 will be obligated to make one or more premium payments to the third company 3 in exchange for this benefit. Since the second company 2 has assigned its rights under the second contract set to the first company 1, the third company's obligation to pay said defined losses is included within the collateral funds. In other words, the collateral funds are substantially equal to said defined losses incurred by the first company if the one or more assets default. The third company 3 is obligated to make available the collateral funds only if the one or more assets default. The credit default swaps can additionally be (but typically are not) structured to pass the risks and rewards of asset appreciation/depreciation onto the third company 3. In other words, the second contract set can obligate (1) the second company 2 to pay the third company 3 an amount of appreciation, if any, of the referenced assets, and (2) the third company 3 to make available to the first company 1 an additional portion of collateral funds equal to the amount of depreciation, if any, of the referenced assets.

In addition to total rate of return swaps and credit default swaps, skilled artisans will appreciate that the first and second contract sets can comprise other types of credit-sensitive derivative contracts without departing from the spirit and scope of the present invention. Also, it will be appreciated that both the first and second contract sets are preferably the same type of transaction. For example, the first and second contract sets are preferably both total rate of return swaps or both credit default swaps, or another type of transaction.

In a typical scenario, the first company 1 is obligated to pay the principal component of its payment obligation to the entities 4 on a specified date, such as the maturity date of short term notes or the end date of a loan term. In some cases, the interest component is also owed on the specified date. In other cases, the interest component is owed at least partially before the specified date, for example in a string of interest payments. In a preferred embodiment, the first and second contract sets require their payment obligations to be netted against one another on or before the specified date for payment of the principal component to the entities 4.

In a preferred embodiment, the first and second contract sets each comprise a Master ISDA Agreement, an ISDA Schedule, and one or more ISDA Confirmations. However, it will be understood that these ISDA agreements provide merely one way to create the desired obligations of the parties, and that other types of contracts can be used to achieve one or more of the goals of the present invention.

The first contract set preferably includes an assignment or pledge of the second company's rights under the second contract set to the first company 1. The terms “assignment” and “pledge” are used herein interchangeably. In particular, the second company 2 preferably pledges, in support of its obligations under the first contract set, its rights under the second contract set. This assignment is also referred to herein as a security interest in the second contract set given by the second company 2 to the first company 1. More preferably, the assignment or pledge is subject to certain “safe harbors.” Most developed legal jurisdictions, such as the member states of the European Union and the United States, have created exceptions or safe harbors for certain financial and derivative transactions (including those documented by Master ISDA Agreements). These exceptions/safe harbors allow the transactions to be terminated immediately and the non-bankrupt entity to enforce on any collateral without delay or interference by a bankruptcy court or administrator. Thus, the first contract set is preferably directed to financial instruments that are entitled to these safe harbors. It will be understood that “swap agreements” as defined in the Bankruptcy Abuse Prevention and Consumer Protection Act of 2005 are subject to these safe harbors. Advantageously, the collateral funds paid by the third company 3 are immediately available to the first company 1 in the event of that the second company 2 enters bankruptcy proceedings and fails to meet its payment obligations to the first company 1 under the first contract set. In one embodiment, the first contract set includes a separate document (such as a Credit Support Annex) that includes the assignment or pledge of the second company's rights under the second contract set to the first company 1. In a preferred embodiment, the first contract set comprises a Master ISDA Agreement, an ISDA Schedule, one or more ISDA Confirmations, and a Credit Support Annex that acts as this separate document.

Thus, a major reason for the second company's pledge of its rights under the second contract set to the first company 1 is to provide collateral for the first company 1. However, this alone is not sufficient to ensure that the first company 1 has enough liquidity to meet its obligations to the entities 4 in the event that the second company 2 goes bankrupt. In the conventional contractual arrangement of FIG. 1, even if the second company 2 pledges to the first company 1 its rights under the eligible swap agreements, the payments made by the third company 3 thereunder can still be diverted by a bankruptcy court or administrator if the second company 2 goes bankrupt. With reference to FIG. 2, this problem is overcome by contractually requiring (under the second contract set) the third company 3 to pay the collateral funds into a separate account 5 owned by the first company 1. The separate account 5 is preferably a segregated trust account at a highly rated financial institution, and is preferably under the sole dominion and control of a collateral agent 6. Since the account 5 does not belong to the second company 2, it will not be considered part of the second company's bankruptcy estate. Since it owns the account 5, the first company 1 will be able to withdraw amounts from the account 5 as and when necessary to make its payments to the entities 4.

The collateral agent 6 is preferably empowered to control the account 5 on behalf of the first company 1. Preferably, the agent 6 withdraws money as necessary when the second company 2 fails to make its required payments to the first company 1. In other embodiments, the agent 6 is omitted from the arrangement, such that the first company 1 directly controls the account 5. In any case, the agent 6 or first company 1 is preferably obligated to return the collateral funds from the account 5 to the second company 2 in the event that the second company 2 meets all of its obligations to the first company 1 under the first contract set and is not bankrupt. For example, the first contract set can require the first company 1 to direct the agent 6 to pay the collateral funds to the second company 2 if the second company (1) makes its required payments to the first company 1 in connection with the interest component of the first company's payment obligation, (2) meets its contingent obligation, if applicable, and (3) is not bankrupt.

The contractual structure of FIG. 2 preferably also eliminates the risk of set-off. Under English law, the ability of a debtor to set-off is terminated at the time of a legal assignment of the debt by the creditor, although crystallized (due and payable) rights of set-off take priority over the legal assignment. If, however, there are no crystallized rights of set-off at the time of the legal assignment, then the assignment will prevent a subsequent occurrence of set-off unless the claim for set-off arises under the same agreement that creates the debt. New York law is very similar. Under New York law, once a debt has been pledged and notice of the pledge has been delivered to the obligor of the debt, no set-off that relates to obligations that mature after notice of the pledge can be applied to payments due under the pledged debt.

The second company's assignment of its rights under the second contract set to the first company 1 constitutes an assignment of the third company's debt owed to the second company 2. Under English law, the assignment acts to eliminate the right of the third company 3 to set-off amounts that it is owed by the second company 2 under unrelated transactions. The assignment is preferably a legal assignment under English law, which requires specific language to be inserted into the first contract set (preferably in a Master ISDA Agreement of the first contract set). Those of skill in the art will understand which language needs to be used in order for the assignment to be valid under English law. Preferably, the second company 2 additionally provides notice to the third company 3 of the assignment. In a preferred embodiment, written notice of the assignment is included in the second contract set, and more preferably in a Master ISDA Agreement, for the purpose of cutting off set-off rights. In other words, the second contract set preferably includes notification language that notifies the third company 3 that the second company 2 has assigned the second company's rights under the second contract set to the first company 1, the notification language preventing the third company from applying set-off to payment obligations under the second contract set.

A bank will often enter into a single derivative contract set (e.g., a Master ISDA Agreement and supporting documents as discussed above) with a particular counterparty, with the intent to have the agreement cover a number of different derivative transactions to facilitate set-off across all of the transactions. However, the second company 2 may wish to enter into a separate derivative contract set to be used exclusively for this business—the facilitation of the third company's acquisition of the risks and rewards of the referenced assets' appreciation/depreciation without the third company 3 becoming directly exposed to the assets. For example, the second company 2 may decide to enter into first and second sets of Master ISDA Agreements and ISDA supporting documents (each set an “ISDA Agreement”) with the third company 3, wherein the first ISDA Agreement applies to the ordinary swaps and derivatives transactions between the companies and the second ISDA Agreement is used exclusively for this business. This way, the third company 3 can have set-off rights with respect to the ordinary derivatives transactions between the second and third companies, but not with respect to obligations that the second company 2 assigns over to the first company 1 as described above.

The contractual structure illustrated in FIG. 2 and described above has a variety of advantages over the conventional arrangement shown in FIG. 1. From the standpoint of the first company 1, credit and liquidity support is received from both the second company 2 and third company 3, despite the fact that the first company 1 is in contractual probity only with the second company 2. Moreover, the collateral funds received from the third company 3 will remain available to the first company 1 in the event that the second company 2 becomes bankrupt. Also, since the first company 1 receives credit and liquidity support from two companies, it can have a high rating as long as one of the two companies also has a high rating. The fact that one of the second and third companies may have a lower rating will not necessarily limit the rating of the first company 1, as long as the other of the second and third companies has a high rating. In some cases, it may even be possible for the first company 1 to have a high rating when both the second and third companies have lower ratings, due to the fact that the first company 1 receives credit and liquidity support from the two companies, as opposed to just one of them.

For example, suppose the second company 2 is a bank rated P-2 by Moody's and A-2 by S&P, and the third company 3 is a bank rated P-1 by Moody's, A-1 by S&P, and F1 by Fitch. Since the third company 3 has higher ratings, the first company 1 can issue debt instruments with higher ratings despite the fact that the second company 2 has lower ratings. The ratings of the first company 1 are advantageously delinked from those of the second company 2. The second company 2 can be an operating company without necessarily having an adverse effect on the rating of the first company 1. In conventional arrangements (such as shown in FIG. 1), if the credit and liquidity support is filtered through an operating company (e.g., the second company 2), as opposed to a bankruptcy-remote entity, the first company's ratings could be lower. However, in contractual arrangements according to embodiments of the present invention, the credit and liquidity support can be filtered through an operating company (the second company 2) without having an adverse effect on the ratings of the first company 1. The first company 1 can issue instruments with high ratings despite the fact that the company providing funds for the payment of the notes (company 2) has lower ratings.

An example is now provided to illustrate a contractual arrangement according to an embodiment of the present invention. With reference to FIG. 2, suppose the first company 1 issues short term (e.g., three month) notes to entities 4 at a face value of $100 for a discounted value of $98. In other words, the first company 1 receives $98 for each note and is obligated to repay $100. For each note, the principal component of the payment obligation is $98 and the interest component is $2. Now suppose the first, second, and third companies enter into the first and second contract sets as described herein and illustrated in FIG. 2, wherein each contract set effects a total rate of return swap that transfers all of the risks and rewards of asset value fluctuation. The first company 1 purchases assets to hedge its obligation to the second company 2. At the time that the first and second contract sets are executed, the total value of the assets is substantially equal to the total principal component of the short term notes. For simplicity, suppose the number of assets is equal to the number of notes, and each asset is worth $98 when the first and second contract sets are executed. Now suppose the assets are worth only $95 (a depreciation of $3) on an agreed-upon date for “netting” the obligations of the companies, the netting date being on or before the maturity date of the notes. On the netting date, the second company 2 owes the first company 1 (at least) $2 for the interest payment and $3 for the asset depreciation, for a total of $5 per asset. Likewise, the third company 3 is also obligated to pay $5 per asset into the account 5, as collateral funds. If the second company 2 meets its payment obligations to the first company 1, then the first company can sell the assets at $95 and, combined with the $5 payment received from the second company 2, pay $100 per note as owed to the entities 4. However, if the second company 2 goes bankrupt or is otherwise unable to meet its payment obligations to the first company 1, then the first company can foreclose on the collateral funds in the account 5. Therefore, the arrangement provides the first company 1 with enough liquidity support even if the second company 2 fails to meet its obligations.

Although the invention has been disclosed in the context of certain embodiments and examples, it will be understood by those skilled in the art that the invention extends beyond the specifically disclosed embodiments to other alternative embodiments and/or uses and obvious modifications and equivalents thereof. Accordingly, the invention is not intended to be limited by the specific disclosures of preferred embodiments herein.

1. A contractual structure comprising:
a first company having a payment obligation to one or more entities in accordance with one or more schedules;
a second company;
a third company;
a first set of one or more derivative contracts between the first and second companies, the first contract set apportioning risks and rewards between the first and second companies of a possible default or value change of one or more assets referenced in the first contract set; and
a second set of one or more derivative contracts between the second and third companies, the second contract set obligating the third company to make collateral funds available to the first company to fully enable or assist the first company in fulfilling the payment obligation to the one or more entities, at least a portion of the collateral funds being contingent upon a default or depreciation of the one or more referenced assets.

2-19. (canceled)

20. A method comprising:
entering into a first set of one or more derivative contracts with a first company that has a payment obligation to one or more entities in accordance with one or more schedules;
agreeing under the first contract set to an apportionment with the first company of risks and rewards associated with a possible default or value change of one or more assets referenced in the first contract set; and
entering into a second set of one or more derivative contracts with a counterparty, the second contract set obligating the counterparty to make collateral funds available to the first company to fully enable or assist the first company in fulfilling the payment obligation to the one or more entities, at least a portion of the collateral funds being contingent upon a default or depreciation of the one or more referenced assets.

21. The method of claim 20, further comprising assigning all rights obtained under the second contract set to the first company.

22. The method of claim 21, wherein the assigning step comprises agreeing under the first contract set to assign to the first company all rights obtained under the second contract set.

23. The method of claim 21, further comprising notifying the counterparty of said assigning step.

24. The method of claim 23, wherein notifying the counterparty of said assigning step comprises including in the second contract set notification language that notifies the counterparty of said assignment to the first company of all rights obtained under the second contract set.

25. The method of claim 24, wherein the notification language prevents the counterparty from applying set-off to the counterparty's payment obligations under the second contract set.

26. The method of claim 20, further comprising agreeing under the first contract set to pay the first company defined losses incurred by the first company in the event of a default of the one or more assets, the collateral funds being substantially equal to said losses incurred by the first company if the one or more assets default, the counterparty being obligated to make available the collateral funds only if the one or more assets default.

27. The method of claim 26, further comprising:
obtaining a right under the first contract set to receive from the first company one or more premium payments; and
agreeing under the second contract set to make one or more premium payments to the counterparty.

28. The method of claim 20, further comprising:
agreeing under the first contract set to make one or more payments to the first company that are sufficient to be used by the first company to fulfill an interest component of the payment obligation to the one or more entities;
obtaining a right under the first contract set to receive from the first company an amount of appreciation, if any, of the one or more assets;
agreeing under the first contract set to pay the first company an amount of depreciation, if any, of the one or more assets; and
agreeing under the second contract set to pay the counterparty the amount of appreciation, if any;
wherein the collateral funds comprises one or more payments sufficient to be used by the first company to fulfill the interest component of the payment obligation to the one or more entities, the collateral funds further comprising the amount of depreciation, if any, of the one or more assets.

29. The method of claim 28, further comprising obtaining under the first contract set a right to receive the collateral funds from the first company if the counterparty pays the collateral funds to the first company and said one or more payments to the first company under the first contract set are fully made.

30. The method of claim 28, wherein the first company is obligated to pay a principal component of the payment obligation to the one or more entities on a specified date, the first company being obligated to pay the interest component to the one or more entities in a string of payments substantially prior to the specified date, the method further comprising agreeing under the first contract set to make said one or more payments to the first company under the first contract set according to a schedule that allows the first company to use the scheduled payments to fulfill the interest component of the first company's payment obligation to the one or more entities, wherein the second contract set requires the counterparty to make available said one or more payments of the collateral funds according to a schedule that allows the first company to foreclose on said one or more payments of the collateral funds to fulfill the interest component of the first company's payment obligation to the one or more entities in accordance with the one or more schedules associated with the entities.

31. The method of claim 20, wherein the second contract set obligates the counterparty to pay said collateral funds into an account owned by the first company.

32. The method of claim 31, wherein the account is a segregated trust account controlled by a collateral agent.

33. The method of claim 20, wherein entering into the first contract set comprises entering into a Master ISDA Agreement, an ISDA Schedule, one or more ISDA Confirmations, and a document that includes an assignment to the first company of all rights obtained under the second contract set, and wherein entering into the second contract set comprises entering into a Master ISDA Agreement, an ISDA Schedule, and one or more ISDA Confirmations.

34. The method of claim 20, further comprising being an operating company that is not a bankruptcy-remote entity.

35. The method of claim 20, wherein the first company is a special purpose vehicle.

36. The method of claim 20, wherein the first company owns the one or more referenced assets or one or more assets whose total value is substantially equal to that of the one or more referenced assets.

37. The method of claim 20, wherein the first company is obligated to pay both a principal component and an interest component of the payment obligation to the one or more entities on a specified date, the first contract set requiring payment obligations of said contract sets to be fulfilled on or before the specified date.

38. The method of claim 20, wherein at a time of execution of the first or second contract set, the one or more assets have a total value that is substantially equal to a principal component of the first company's payment obligation.

39. The method of claim 20, further comprising:
obtaining a right under the first contract set to receive from the first company any return associated with ownership of the one or more referenced assets; and
agreeing under the second contract set to pay the counterparty said return.

40. A method comprising:
assuming a payment obligation to one or more entities in accordance with one or more schedules;
entering into a first set of one or more derivative contracts with an intermediary company, wherein the intermediary company enters into a second set of one or more derivative contracts with a counterparty;
agreeing under the first contract set to an apportionment with the intermediary company of risks and rewards associated with a possible default or value change of one or more assets referenced in the first contract set; and
obtaining a right under the second contract set to receive from the counterparty collateral funds that can be used to at least partially fulfill the payment obligation to the one or more entities, at least a portion of the collateral funds being contingent upon a default or depreciation of the one or more assets.

41. The method of claim 40, further comprising obtaining under the first contract set an assignment by the intermediary company of the intermediary company's rights under the second contract set.

42. A method in which an intermediary company has entered into a first set of one or more derivative contracts with a first company that has a payment obligation to one or more entities in accordance with one or more schedules, the first contract set apportioning between the first company and the intermediary company risks and rewards associated with a possible default or value change of one or more assets referenced in the first contract set, the method comprising:
entering into a second set of one or more derivative contracts with the intermediary company; and
agreeing under the second contract set to make collateral funds available to the first company to fully enable or assist the first company in fulfilling the payment obligation to the one or more entities, at least a portion of the collateral funds being contingent upon a default or depreciation of the one or more referenced assets.

43. The method of claim 42, wherein the first contract set includes an assignment of the intermediary company's rights under the second contract set to the first company.
